(19) United States
(12) Patent Application Publication
(10) Pub. No.: US 2022/0226722 A1
(43) Pub. Date: Jul. 21, 2022

(54) TRIGGER STOP FOR GAME CONTROLLER

(71) Applicant: Ghost Trigger LLC, Harrington Park, NJ (US)

(72) Inventors: Fahad Tahir, Brooklyn, NY (US); Aunn Mohammad, Brooklyn, NY (US); Elie Atalla, Harrington Park, NJ (US)

(73) Assignee: Ghost Trigger LLC, Harrington Park, NJ (US)

(21) Appl. No.: 17/577,004

(22) Filed: Jan. 16, 2022

Related U.S. Application Data
(60) Provisional application No. 63/138,442, filed on Jan. 16, 2021.

(51) Int. Cl. A63F 13/24

(52) U.S. Cl. CPC A63F 13/24

(57) ABSTRACT

The present invention is a trigger stop device for use with a video game controller having at least one trigger. The trigger stop device has the same number of stoppers that the video game controller has triggers. The release point of each trigger is determined experimentally. The trigger stop device is affixed to the video game controller such that an upper portion of each stopper has a line-to-line fit with a prominence of each trigger. In this way, the trigger stop device stops the trigger travel at the release point. A user will be able to depress the trigger to a hard-stop more quickly. The trigger will rebound more quickly.

### CROSS REFERENCE TO RELATED APPLICATIONS

The present application is a non-provisional of U.S. provisional Utility Patent Application No. 63/138,442, filed Jan. 16, 2021, and entitled, “Trigger Stop for Game Controller,” which is incorporated herein by reference.

### FIELD OF INVENTION

This invention relates to the classification of video games, and to one or more sub-classifications input arrangements for video game devices and construction details thereof. Specifically, this invention is a trigger stop that is mountable to trigger-style video game controllers.

### BACKGROUND OF INVENTION

Simple video games have evolved into sophisticated virtual reality gaming experiences. This evolution has greatly impacted the importance of the controllers used to play them. These are generally remote, wireless controllers that include an array of joysticks, push buttons and triggers. Many games have become globally popular, in particular many games that require a player to rapidly and repeatedly pull back and release trigger style controls. In competitive situations, players with the faster rate of firing, aka Trigger Releases, will have a significant advantage over their opponents. Typically, a trigger can be pulled back, against the counter-force of an internal spring, into the game controller from an extended position that is several millimeters (e.g. 10 mm) out from a fully depressed position where it is forced to stop. The amount of movement from the dormant, fully extended position to the fully depressed position is the total Trigger Travel that is inherent in the controller's design. Trigger Travel can be divided into two important parts. The Pre-Travel, which is the distance from the dormant position to the point at which the trigger makes contact with an internal sensor. This point is also called the Trigger Release because it is the point at which a signal is sent to the controller's circuit board; that signal indicates that a desired action has been taken by the player and should therefore be simulated in the virtual, video game being played. The second part of the Trigger Travel occurs after the Release and is the distance from the Release point to the fully depressed position. This is described as “Over Travel” because it is in excess of what is required to have the desired effect of pulling the trigger. After the full Trigger Travel is complete, or when a player otherwise senses that the action has been Released, the player can release the trigger and it will spring back into its extended, dormant state once again.

The problem is that there is a significant delay caused by Over Travel and the subsequent reverse travel from fully depressed to fully extended. The time it takes for the trigger to be fully depressed beyond its Release point and the time it takes for the internal spring to push it back to its fully extended position is much longer than necessary and therefore will slow a players ability to repeatedly activate the action caused by the trigger's release. This problem creates a need for a device that can stop the trigger at a desired point, typically just beyond the Pre-Travel and just after the Trigger Release has occurred. If a device or “Trigger Stop”, that prevents Over-Travel, can be installed onto an existing controller, such a device would give the player the ability to quickly reset and re-release the trigger in rapid succession.

An additional problem or challenge is the way in which modern game controllers are designed. They are generally devoid of hard edges or attachment points. While this makes them extremely ergonomic, it also prevents attachments or devices from being mounted securely and simultaneously supporting, counteracting and dissipating forces that are exerted upon them by the trigger movements.

Finally, when and if a Trigger Stop is attached to the game controller, it can then become an impediment when a player wishes to switch from playing a game that requires a trigger stop to a game that does not. Thus, a device designed to be a Trigger Stop which can help a player in one game can become a handicap in another, and therefore must be removed from the controller, which of course is an inconvenience.

### SUMMARY OF THE INVENTION

This summary is intended to disclose the present invention, a trigger stop for a video game controller. The embodiments and descriptions are used to illustrate the invention and its utility and are not intended to limit the invention or its use. The following presents a simplified summary of the primary embodiment of the invention to provide a basic understanding of the invention. Additional concepts that can be added or varied with the primary embodiment are also disclosed. The present invention is novel with respect to the prior art, and can be distinguished from the prior art.

The trigger stop for a video game controller is device that can be mounted onto the back of a video game controller and is stable enough to hold a mechanism in place that controls structures called stoppers. It is comprised of an integrally molded base, at least one stopper, at least one fixed rod, and central rod bracket. The stoppers can be positioned, in a deployed state, directly below the triggers of the video game controller, such that lower surface of the trigger, called the trigger lip, will come in direct contact with the a contoured upper surface of the upper portion of the stopper.

A typical video game controller has at least one handle with which a user grabs it, at least one joystick, at least one set of buttons, and at least one trigger. Many of the most popular video game controllers have two handles, two joy sticks, two sets of buttons, and two triggers.

The triggers are typically rear-mounted. The trigger has a prominence called a trigger lip. The triggers can be pulled into a fully depressed position, at which point further trigger travel is stopped by an internal structure. In the fully depressed position, the trigger lip is just above the upper lip of the game controller housing. The distance between the trigger in its default position and in its fully depressed position is referred to full trigger travel. The trigger will travel some distance (“pre-travel”) before it activates an internal sensor within the video game controller. The position of the trigger when it activates the internal sensor is referred to as the release point. This is when the trigger fires. The release point has to be determined, or pre-defined, prior to attaching the present invention to the video game controller. This can be done by depressing the trigger until it fires, and then drawing a line on the trigger at the housing lip. The housing lip is where the housing meets the trigger. The pre-travel is significantly shorter than the full trigger travel. The present invention is a trigger stop for a video game controller in which a stopper stops the trigger just past the release point, preventing the user from fully depressing the trigger.

The stopper has a lower portion and an upper portion. Typically, the lower portion is fixed, as it is part of an integrally molded base. However, this is not a limitation of the present invention. The upper portion of the stopper is designed to have line-to-line fit with the trigger lip of the trigger when it reaches the release point. Any further depression of the trigger results in an interference fit between the trigger and the upper portion of the stopper.

The invention one stopper per trigger. Since most video game controllers have two triggers, the illustrated embodiments will teach a trigger stop for a video game with two stoppers. For ease of terminology, one trigger will be the left trigger and one trigger will be the right trigger. One stopper will be the left stopper and it will stop the left trigger. One stopper will be the right stopper and it will stop the right trigger.

The upper portion of the stopper is movable on fixed rods. A central rod bracket supports the fixed rods. The upper portion has an angular support arm and a carriage body. The angular support arm meets with and locks to the top surface of the lower portion. The upper portion of the stopper is shorter than the trigger and sits under the trigger lip when the trigger is in its default position. It is designed so that the trigger can reach the release point prior to the trigger lip encountering the upper portion of the stopper. When a player attempts to fully depress the trigger, the upper portion comes into direct contact with the trigger lip and stops further trigger travel. The upper portion is purposefully contoure to the shape of the trigger in the area where the trigger will encounter the stopper.

The carriage body fits into a track in the base. The rods insert into the carriage body at openings in the carriage body and pass through the carriage body. Thus, the upper portion is able to slide back and forth on the fixed rod.

One or more pieces of pressure sensitive adhesive (“PSA”) can be affixed to the inner surface of the integrally molded base in order to attach the present invention to the video game controller.

The arrangement of components is critical. The stoppers have to be arranged so that they cause a line-to-line fit between the upper portion and the trigger lip at the trigger release point. This prevents the player from fully depressing the trigger to their fully depressed position. The time saved from limiting the trigger travel to stop at the release point, versus the full trigger travel is critical during virtually every game involving the triggers. The force from the trigger striking the trigger stop is transmitted into the upper portion which, in turn, transmits it to the lower portion and the integrally molded base. The present invention allows the upper portion and lower portion to exhibit a small amount of flexing, in order to ensure that the trigger is actuated before it is released.

The trigger stop for a video game controller allows the user to position the stopper directly in the path of, and opposite to the direction of travel, for each trigger, respectively. By allowing the upper portion to move on the fixed rods, the user can move the trigger stops out of the way if desired. When they are fully retracted, the stoppers are positioned in a neutral area, in the middle of the rear of the video game controller. With the stoppers positioned in this area, the present invention does not interfere with the video game controllers functions, including those used for gripping and activating the various controls.

When a user wants the trigger stops engaged, the user may simply place the tip their index finger on the carriage body of each trigger stop and pull the carriage bod along the fixed rods until the upper portion is properly positioned. By contouring the upper portion to mate with the segmented top surface of the lower portion, the upper portion can be easily locked into position for game play. Alternately, set screws can be inserted into holes in the carriage body in order to lock the upper portion in place. The carriage body can be textured to facilitate its movement during game play.

The invention can be tailored for any video game controller by measuring the dimensions of the video game controller. The positions of all key structures are identified. Care must be taken not to allow the trigger stops for video game controllers to interfere with the triggers, buttons, and joysticks of the video game controller in an unintended fashion.

### BRIEF DESCRIPTION OF THE DRAWINGS

The present invention is illustrated with 13 drawings on 14 sheets.

FIG. 1 is a front view of an exemplar of a prior art video game controller.

FIG. 2 is a perspective view of an exemplar of a prior art video game controller.

FIG. 3 is an isolation side view of an exemplar of a prior art video game controller showing the triggers.

FIG. 4 is a close-up isolation side view of showing a first embodiment of a trigger stop for a video game controller attached to a video game controller.

FIG. 5 is a rear perspective view of a first embodiment of the trigger stop for a video game controller attached to a video game controller.

FIG. 6 is a perspective isolation view of the first embodiment of the trigger stop for a video game controller attached to a video game controller.

FIG. 7 is a rear view of the first embodiment of the trigger stop for a video game controller.

FIG. 8A is a perspective view of a second embodiment of a trigger stop for a video game controller.

FIG. 8B is an exploded view of a second embodiment of a trigger stop for a video game controller.

FIG. 9A is a rear view of a second embodiment of a trigger stop for a video game controller, illustrating the removal of a protective cover from a pressure sensitive adhesive.

FIG. 9B is a rear view of a second embodiment of the trigger stop for a video game controller with the pressure sensitive adhesive exposed.

FIG. 10A is a side view showing the second embodiment of the trigger stop for a video game controller being attached to an exemplar of a video game controller.

FIG. 10B is a side view showing the second embodiment of the trigger stop for a video game attached to a video game controller.

FIG. 11A is a rear perspective view of the second embodiment of the trigger stop for a video game attached to a video game controller, showing the present invention's deployment into operation.

FIG. 11B is a rear view of the second embodiment of the trigger stop for a video game attached to a video game controller, showing the present invention's deployment into operation.

FIG. 11C is a rear perspective view of the second embodiment of the trigger stop for a video game attached to a video game controller, showing the present invention's deployed.

FIG. 12 is an exploded view of a third embodiment of a trigger stop for a video game controller.

FIG. 13A is a rear perspective view of the third embodiment of the trigger stop for a video game attached to a video game controller, showing the present invention's deployment into operation.

FIG. 13B is a rear view of the third embodiment of the trigger stop for a video game attached to a video game controller, showing the present invention's deployment into operation.

FIG. 13C is a rear perspective view of the third embodiment of the trigger stop for a video game attached to a video game controller, showing the present invention's deployed.

### DETAILED DESCRIPTION OF THE DRAWINGS

The following descriptions are not meant to limit the invention, but rather to add to the summary of invention, and illustrate the present invention, by offering and illustrating various embodiments of the present invention, a trigger stop for a video game controller. In the illustrated embodiments, the trigger stop for a video game controller is shown in various embodiments with various video game controllers. While embodiments of the invention are illustrated and described, the embodiments herein do not represent all possible forms of the invention. Rather, the descriptions, illustrations, and embodiments are intended to teach and inform one skilled in the art without limiting the scope of the invention.

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import. These words are meant to convey the relative topology and layout of the invention presented in the illustrations, but it is not meant to limit the scope of the invention.

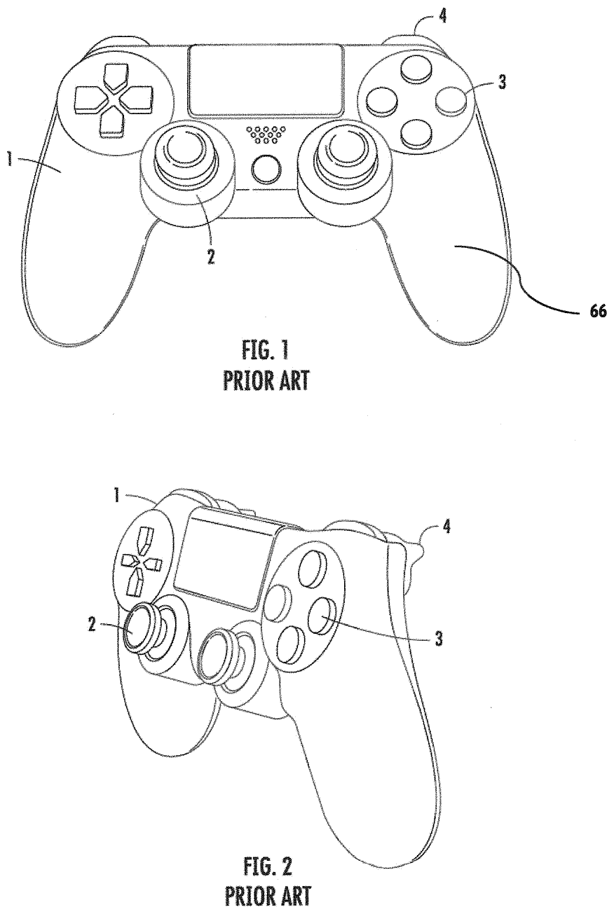

FIGS. 1-3 show a prior art video game controller 1 exemplar. This exemplar 1 can represent many different video game controllers 1 for many different video gaming systems. The video game controller 1 has at least one handle 66 with which a user grabs the video game controller 1, at least one joystick 2, at least one set of buttons 3, and at least one trigger 4, 44. In this prior art exemplar, the video game controller 1 has two handles 66 with which a user grabs the video game controller 1, two joysticks 2, two sets of buttons 3, and two triggers 4, 44. The triggers 4, 44 are typically located in the rear of the video game controller 1. The trigger 44 has a trigger lip 44a, which is a prominence 44a on the trigger 44. The triggers 4, 44 can be pulled into a fully depressed position at 5, at which point further trigger 4 travel is stopped by an internal structure. This fully depressed position 5 is just above the upper lip 6 of the game controller housing 67. The distance between the trigger 4 in its default position 4 and in its fully depressed position 5 is referred to full trigger travel 68.

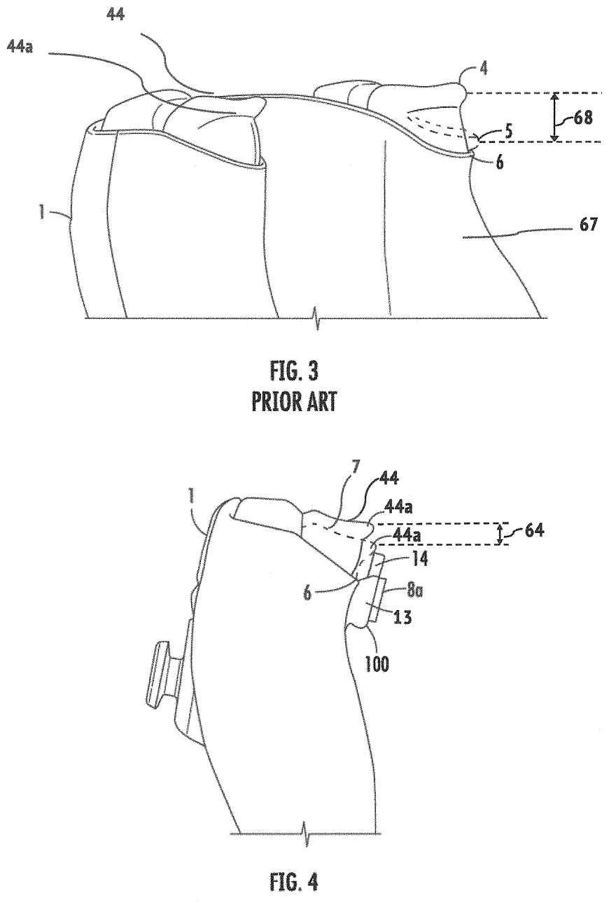

Referring now to FIG. 4, the video game controller 1 is shown with a first main embodiment of the trigger stop for a video game controller 100. The trigger 44 will travel some distance (“pre-travel”) 64 before it activates an internal sensor within the video game controller 1. The position of the trigger 44 when it activates the internal sensor is referred to as the release point 7. The pre-travel 64 is significantly shorter than the full trigger travel 68. The trigger 44 will also rebound more quickly to the default position 44 when stopped at the release point 7. A stopper 8a has a lower portion 13 and an upper portion 14. The upper portion 14 of the stopper 8a is designed to have line-to-line fit with the trigger lip 44a of the trigger 44 when it reaches the release point 7. Any further depression of the trigger 44 results in an interference fit between the trigger 44 and the upper portion 14 of the stopper 8a.

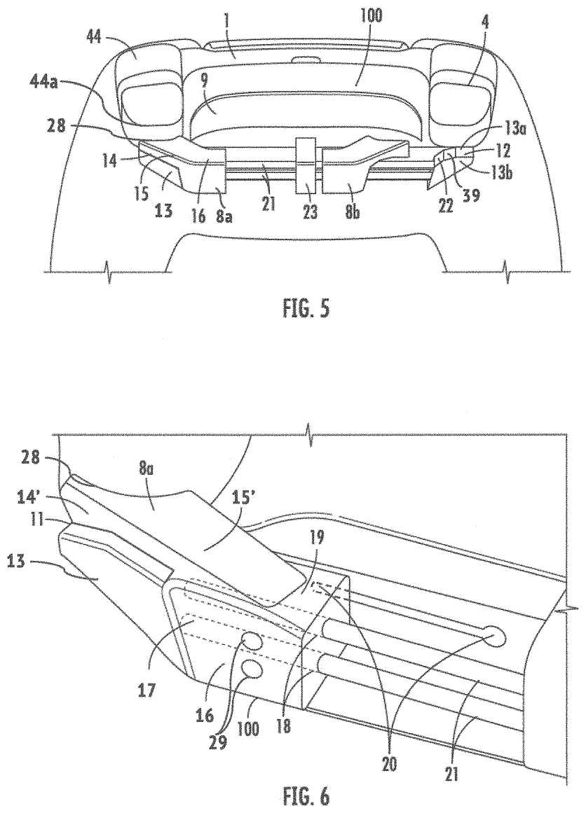

Referring now to FIG. 5, also, positional nomenclature must first be discussed. Viewing the video game controller 1 from the rear, there is a left trigger 44 and a right trigger 4. The present invention 100 has an integrally molded base 9. The invention 100 includes two stoppers, 8a and 8b. One stopper 8a stops the left trigger 44 and one stopper 8b stops the right trigger 4. The stopper 8a is comprised of a lower portion 13 and an upper portion 14. The upper portion 14 is movable on fixed rods 21. A central rod bracket 23 supports the fixed rods 21. There are two fixed rods 21 arranged parallel with one another, so that one is relatively above the other. In one alternative embodiment, the lower portion 13 is fixed; in another alternative embodiment, the lower portion 13 is also movable along the fixed rods 21. The lower portion 13 has a side surface 13b and a segmented top surface 13a, comprised of discernible surfaces 12, 39, 22.

The upper portion 14 has an angular support arm 15 and a carriage body 16. The angular support arm 15 meets with and locks to the top surface 13a of the lower portion 13. The upper portion 14 of the stopper 8a is shorter than the trigger 44 and sits under the trigger lip 44a when the trigger 44 is in its default position. It is designed so that the trigger 44 can reach the release point 7 prior to the trigger lip 44a encountering the upper portion 14 of the stopper 8a. When a player fully depresses the trigger 44, the upper portion 14 comes into direct contact with the trigger lip 44a. The upper portion 14 is purposefully contoured 28 to the shape of the trigger 44 in the area where the trigger 44 will encounter the stopper 8a.

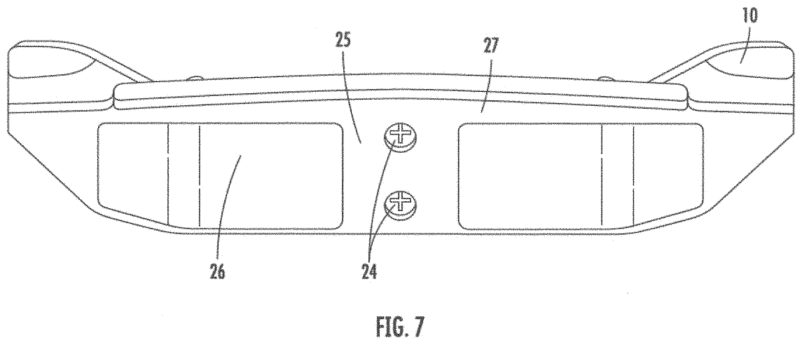

FIG. 6, a close-up of the right stopper 8a shows some additional detail of the first main embodiment of the invention 100. FIG. 6 also shows some minor alternative embodiments of the first main embodiment of the invention 100. The carriage body 16 fits into a track 20 in the base 9. The rods 21 insert into the carriage body 16 at openings 18. The rods 21 pass through 17 the carriage body 16, so that the carriage body 16 is free to slide on the rods 21. Two openings 29 in the carriage body 16 can accept set screws to hold the stopper 8a in place during game play.

The topography of the upper portion 14′ and the angular support arm 15′ can be adjusted in order to fit the particular contours of the video game controller 1. In this minor alternative embodiment, the angular support arm 15 rises out of the top surface 19 of the carriage body 16. In this way, the upper portion 14 can conform to the geometry of the trigger 44 of the video game controller 1. The lower portion 13 and the upper portion 14′ meet 11 with a snug, angled fit that holds them together.

FIG. 7 shows the inner surface 25 of the present invention 100. Two threaded fasteners 24 pass through the inner surface 25 and attach to the central rod bracket 23 to hold the fixed rods 21 in place. One or more pieces of pressure sensitive adhesive (“PSA”) 26 can be affixed to the inner surface 25 in order to attach the present invention 100 to the video game controller 1. A gap 27 is left at the top 27 of the inner surface 25, so that the PSA 26 does not interfere with any part of the triggers 4, 44. The rear surface 10 of the upper portion 14 is visible in this view.

The arrangement of components is critical. The stoppers 8a, 8b have to be arranged so that they cause a line-to-line fit between the upper portion 14 and the trigger lip 44a at the trigger release point 7. This prevents the player from fully depressing the trigger 4, 44 to their fully depressed position 5. The time saved from limiting the trigger travel 64 to stop at the release point 7, versus the full trigger travel 68 is critical during virtually every game involving the triggers 4, 44. The force from the trigger 4, 44 striking the trigger stop 8a, 8b is transmitted into the upper portion 14. The present invention 100 uses the upper portion 14 and lower portion 13 to provide a small amount of flexing, in order to ensure that the trigger 4, 44 is actuated before it is released.

The trigger stop for a video game controller 100 allows the user to position the stopper 8a, 8b directly in the path of, and opposite to the direction of travel, for each trigger 44, 4, respectively. By allowing the upper portion 14 to move on the fixed rods 21, the user can move the trigger stops 8a, 8b out of the way if desired. When they are fully retracted, the stoppers 8a, 8b are positioned in a neutral area, in the middle of the rear of the video game controller 1. With the stoppers 8a, 8b positioned in this area, the present invention 100 does not interfere with the video game controllers 1 functions, including those used for gripping and activating the various controls 2, 3, 4, 44. When a user wants the trigger stops engaged 8a, 8b, the user may simply place the tip their index finger on the carriage body 16 of each trigger stop 8a, 8b and pull the carriage body 16 along the fixed rods 21 until the upper portion 14, 14′ is properly positioned. By contouring the upper portion 14, 14′ to mate with the segmented top surface 13a of the lower portion, the upper portion 14, 14′ can be easily locked into position for game play. Alternately, set screws can be inserted into holes 29 in the carriage body 16 in order to lock the upper portion 14′ in place. The carriage body 16 can be textured to facilitate its movement during game play.

The invention 100 can be tailored for any video game controller 1 by measuring the dimensions of the video game controller 1. The positions of all key structures are identified. Care must be taken not to allow the trigger stops for video game controllers 100 to interfere with the triggers 4, 44, buttons 3 and joysticks 2 of the video game controller 1 in an unintended fashion.

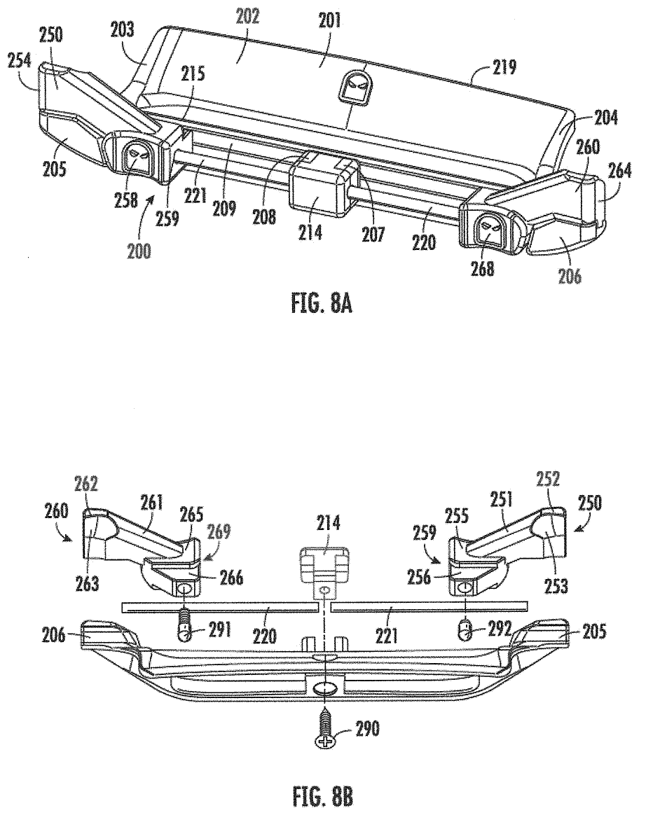

FIGS. 8-11 show a second main embodiment of the trigger stop for a video game controller 200. Referring to 8A and 8B, there is an integrally molded base 201 that has an outer surface 202 comprised of a contoured surface 202 with a left edge 203, a right edge 204, a top edge 219, and a bottom edge 215. The integrally molded base 201 also has a left lower portion 205 and a right lower portion 206. The integrally molded base 201 has a lower surface 209.

A central rod bracket 214 with filleted edges 207, 208 is attached to the lower surface 209 of integrally molded base 201 with a threaded fastener 290. A left fixed rod 221 extends from the left lower portion 205 to the central rod bracket 214. A right fixed rod 220 extends from the right lower portion 206 to the central rod bracket 214. The left fixed rod 221 and the right fixed rod 220 are in-line with one another.

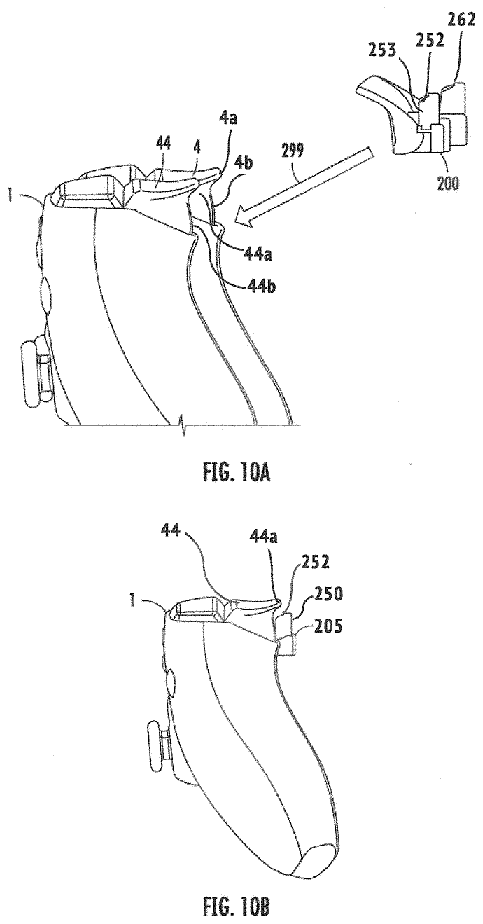

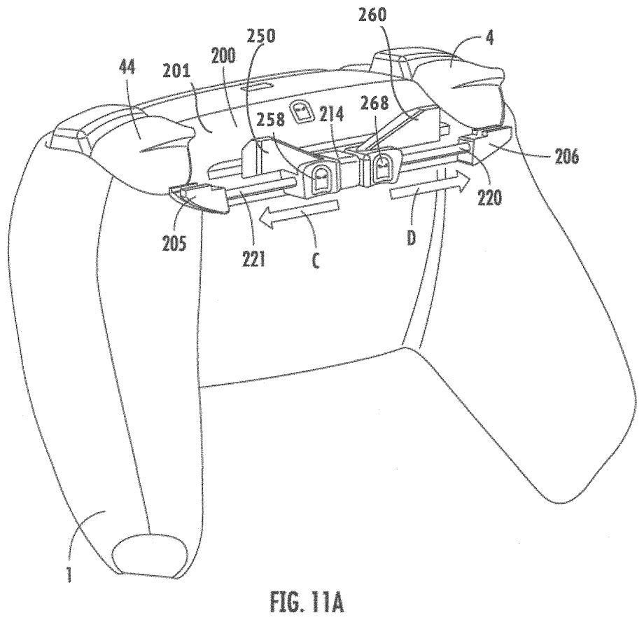

A left upper portion 250 has an angular support arm 251 and a carriage body 256; a right upper portion 260 has an angular support arm 261 and a carriage body 266. The angular support arm 251, 261 of the upper portion 250, 260 rises out of 255, 265 the carriage body 256, 266. Referring now also to FIGS. 10A and 10B, the upper portion 250, 260 has a contoured upper surface 252, 262 that conforms with the trigger lip 44a, 4a. The upper portion 250, 260 has a contoured inner surface 253, 263 that conforms with the trigger body 44b, 4b. When deployed, the outer edge 254 of the left upper portion 250 is flush with the left lower portion 205 and the outer edge 264 of the right upper portion 260 is flush with the right lower portion 206. The left fixed rod 221 passes through a hole 259 in the carriage body 256 of the left upper portion 250. A blind set screw 292 provides friction on the left fixed rod 221, to prevent the left upper portion 250 from sliding to freely. Likewise, the right fixed rod 220 passes through a hole 269 in the carriage body 266 of the right upper portion 260. A blind set screw 291 provides friction on the right fixed rod 220, to prevent the right upper portion 260 from sliding to freely.

On the front-side of the carriage body 256 of the left upper portion 250 is a textured finger hold 258, to making sliding the left upper portion 250 easy. Gentle pressure is applied to the textured finger hold 258 in order to create sufficient surface friction so that the upper portion 250 can be moved. Likewise, on the front-side of the carriage body 266 of the right upper portion 260 is a textured finger hold 268, to making sliding the left upper portion 260 easy. The left trigger stop is comprised of the left upper portion 250 and the left lower portion 205. The right trigger stop is comprised of the right upper portion 260 and the right lower portion 206.

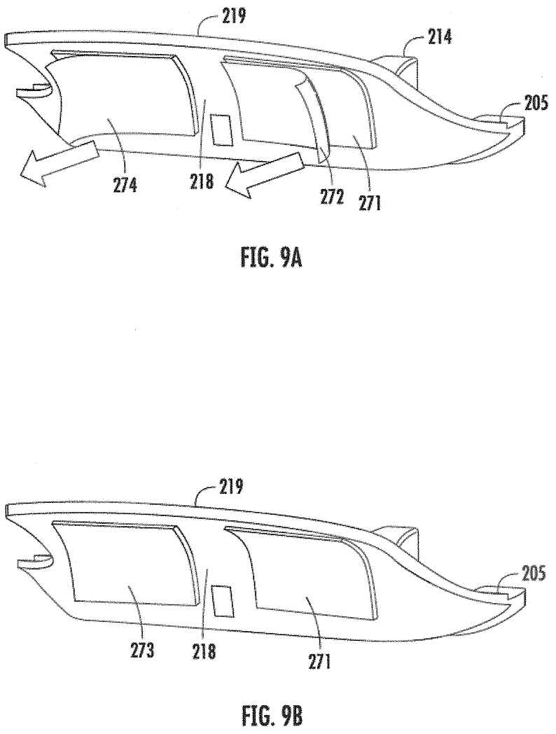

Referring now also to FIGS. 9A and 9B, the integrally molded base 201 has an inner surface 218. The inner surface has PSA 271, 273 in order to affix the present invention 200 to a video game controller 1. The PSA 271, 273 is initially covered with peelable covers 272, 274. As shown in FIGS. 10A and 10B, once the peelable covers 272, 274 are peeled off of the PSA 271, 273, the trigger stop for a video game controller 200 is pressed onto the video game controller. The trigger stop for a video game controller 200 is positioned 299 so that the contoured upper surface 252, 262 that meets with the trigger lip 44a, 4a at the release point 64 and the contoured inner surfaces 253, 263 abut the trigger body 44b, 4b.

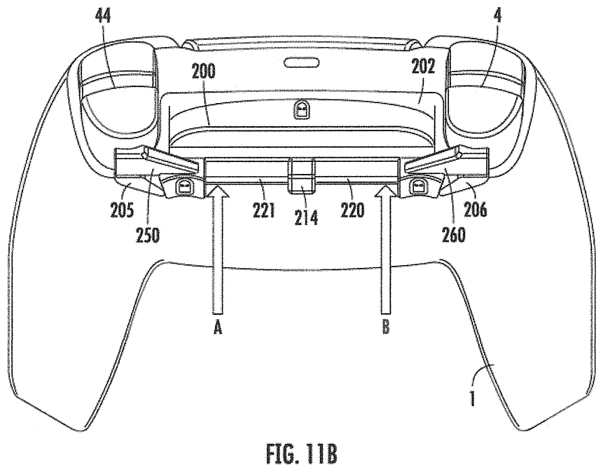

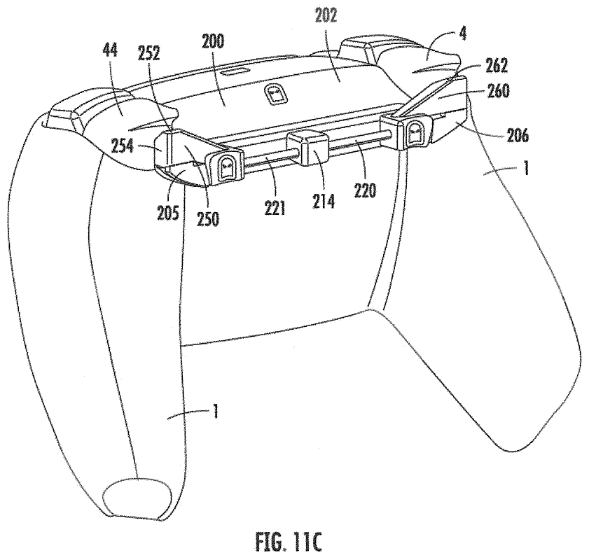

FIG. 11A shows the present invention 200 after being aligned to a video game controller 1. The left upper portion 250 and the right upper portion 260 abut the central rod bracket 214. By applying pressure at the textured finger hold 258, the left upper portion 250 can be moved left (C) along the fixed rod 221. Likewise, by applying pressure at the textured finder hold 268, the right upper portion 260 can be moved right (D) along the fixed rod 220.

In FIG. 11B, with the upper portions 250, 260 positioned above their respective lower portions 205, 206, force (A and B) is applied to the present invention 200 to affix it to the video game controller 1 with the PSA 271, 273.

FIG. 11C shows a properly aligned and affixed trigger stop for a video game controller 200. The upper portions 250, 260 are positioned above their respective lower portions 205, 206. The contoured upper surfaces 252, 262 will meet their respective triggers 44, 4 at the trigger lip 44a, 4a when the trigger 44, 4 is depressed to the release point 64.

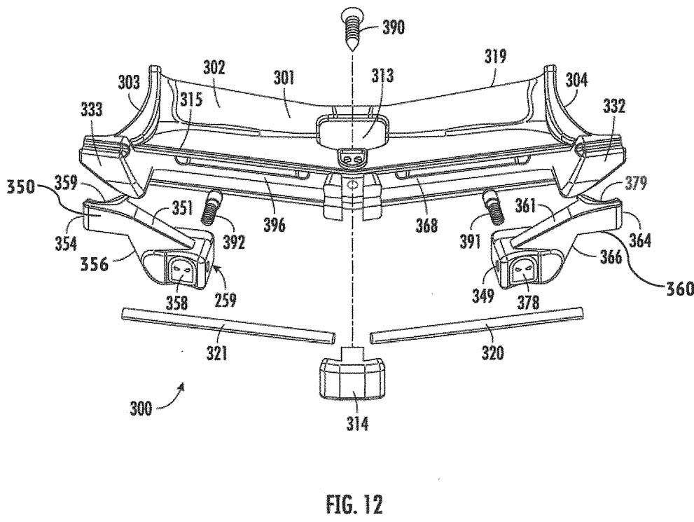

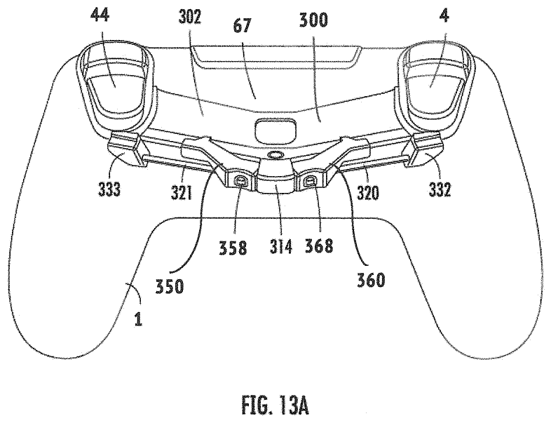

FIG. 12 shows a third main embodiment show a second main embodiment of the trigger stop for a video game controller 300. There is an integrally molded base 301 that has an outer surface 302 comprised of a contoured surface 302 with window 313, a left edge 303, a right edge 304, a top edge 319, and a bottom edge 315. The integrally molded base 301 also has a left lower portion 333 and a right lower portion 332. The integrally molded base 301 has a left lower surface 396 and a right lower surface 368.

A central rod bracket 314 is attached between the left lower surface 396 and a right lower surface 368 of the base 301 with a threaded fastener 390. A left fixed rod 321 extends from the left lower portion 333 to the central rod bracket 314. A right fixed rod 320 extends from the right lower portion 332 to the central rod bracket 314. The left fixed rod 321 and the right fixed rod 320 are at an angle to one another.

A left upper portion 350 has an angular support arm 351 with an outer edge 354, and a carriage body 356; a right upper portion 360 has an angular support arm 361 with an outer edge 364, and a carriage body 366. The angular support arms 351, 361 of the upper portion 350, 360 rises out of the carriage body 356, 366. The upper portion 350, 360 has a contoured upper surface 359, 379 that conforms with the trigger lip 44a, 4a.

The left fixed rod 321 passes through a hole 339 in the carriage body 356 of the left upper portion 350. A blind set screw 392 provides friction on the left fixed rod 321, to prevent the left upper portion 350 from sliding to freely. Likewise, the right fixed rod 320 passes through a hole 349 in the carriage body 366 of the right upper portion 660. A blind set screw 391 provides friction on the right fixed rod 320, to prevent the right upper portion 360 from sliding to freely. The left upper portion 350 has a textured finger hold 358 on the carriage body 356. The right upper portion 360 has a textured finger hold 378 on the carriage body 366.

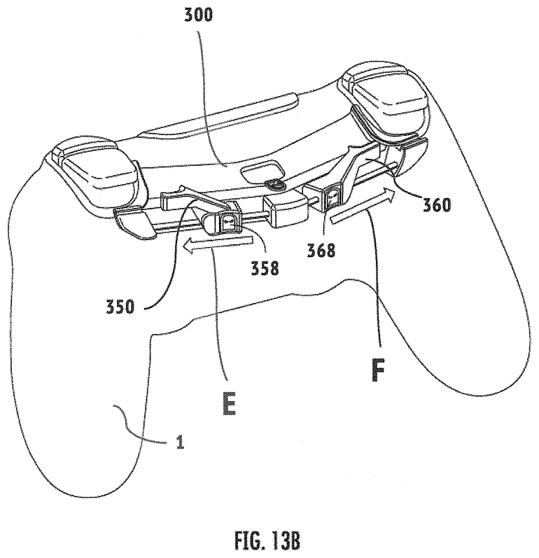

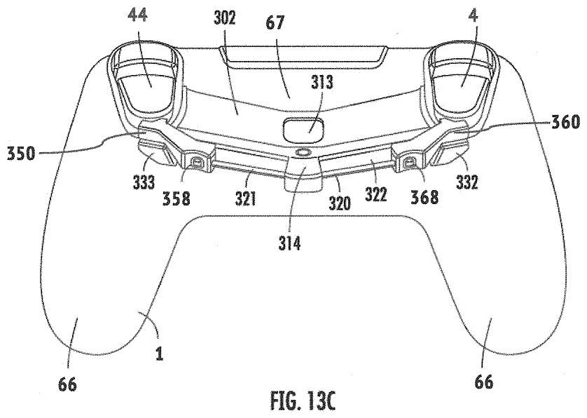

FIG. 13A shows the present invention 300 after being aligned to a video game controller 1. The left upper portion 350 and the right upper portion 360 abut the central rod bracket 314. In FIG. 13B, with the left upper portion 350 is moved left (E) using the textured finger hold 358. The right upper portion 360 is moved right (F) using the textured finger hold 368. FIG. 13C shows a properly aligned and affixed trigger stop for a video game controller 300. The upper portions 350, 360 are positioned above their respective lower portions 333, 332. The integrally molded base 301 has a lower surface 322 in proximity to the fixed rods 321, 320.

We claim:

1. A trigger stop device for use with a video game controller comprised of
an integrally molded base with an inner surface, an outer surface, and a lower surface;
at least one fixed rod;
a central rod bracket; and
at least one stopper comprised of
a lower portion, and
an upper portion having an angular support arm and a carriage base;
wherein a hole in the carriage base of the upper portion of the at least one stopper allows the upper portion to slide along the at least one fixed rod;
wherein the device can be aligned with and affixed to a video game controller;
wherein the video game controller has at least one trigger with a trigger prominence and a trigger body contour;
wherein the at least one trigger travels when depressed; and
wherein when properly aligned and affixed to the video game controller, the upper portion can be deployed to a position in which it will have a line-to-line fit with the trigger prominence at a point in the trigger's travel.

2. The trigger stop device for use with a video game controller of claim 1, wherein the upper portion has a line-to-line fit with the trigger prominence at the release point of the trigger, which is the point of trigger travel at which a sensor internal to the video game controller activates, indicating that the trigger has fired.

3. The trigger stop device for use with a video game controller of claim 2, wherein depressing the trigger will cause it to fire.

4. The trigger stop device for use with a video game controller of claim 3, wherein the trigger travel will stop immediately after the trigger fires, because the trigger prominence will come into contact with the upper portion of the at least one stopper.

5. The trigger stop device for use with a video game controller of claim 4, wherein the amount of time for the trigger to stop when the trigger is depressed with the at least one stopper deployed is shorter than the amount of time for the trigger to stop when the trigger is depressed when the at least one stopper is not deployed.

6. The trigger stop device for use with a video game controller of claim 5, wherein the amount of time for the trigger to rebound with the at least one stopper deployed is shorter than the amount of time for the trigger to rebound when the at least one stopper is not deployed.

7. The trigger stop device for use with a video game controller of claim 6, wherein the upper portion is deployed by sliding it along the fixed rod until it is directly over the lower portion.

8. The trigger stop device for use with a video game controller of claim 7, wherein the upper portion locks to the lower portion.

9. The trigger stop device for use with a video game controller of claim 8, wherein the lower portion is fixed.

10. The trigger stop device for use with a video game controller of claim 9, wherein the lower portion is part of the integrally molded base.

11. The trigger stop device for use with a video game controller of claim 10, wherein the angular support arm of the upper portion of the at least one stopper has a contoured upper surface to match the trigger prominence.

12. The trigger stop device for use with a video game controller of claim 11, wherein the angular support arm of the upper portion of the at least one stopper has a contoured inner surface to match a contour of a trigger body.

13. The trigger stop device for use with a video game controller of claim 12, wherein the carriage body of the upper portion of the at least one stopper has a textured finger hold.

14. The trigger stop device for use with a video game controller of claim 13, wherein the upper portion can be moved along the fixed rod by applying pressure to the textured finger hold.

15. The trigger stop device for use with a video game controller of claim 14, wherein the video game controller has two triggers and wherein there are two stoppers.

16. The trigger stop device for use with a video game controller of claim 15, wherein there are two fixed rods.

17. The trigger stop device for use with a video game controller of claim 16, wherein the two fixed rods are parallel with one another, with one rod being relatively above the other rod.

18. The trigger stop device for use with a video game controller of claim 16, wherein the two fixed rods are in-line with one another.

19. The trigger stop device for use with a video game controller of claim 16, wherein the two fixed rods are at an angle with one another.

20. The trigger stop device for use with a video game controller of claim 16, wherein the two stoppers can be moved to a position wherein they abut the central rod bracket, so that the stoppers are not deployed.

21. The trigger stop device for use with a video game controller of claim 16, further comprising pressure sensitive adhesive, attached to the inner surface of the integrally molded base.

22. The trigger stop device for use with a video game controller of claim 21, wherein the device is affixed to the video game controller with the pressure sensitive adhesive.

23. A method for using a trigger stop device with a video game controller comprising the steps of
determining the release point for each trigger of a video game controller;
using a trigger stop device with the same number of stoppers that the video game controller has triggers;
aligning the trigger stop device with the video game controller such that a contoured upper surface of an upper portion of a stopper creates a line-to-line fit with a trigger prominence of each trigger on the video game controller when the trigger has been depressed to a pre-defined release point;
affixing the trigger stop device to the video game controller using pressure sensitive adhesive; and
deploying each stopper of the trigger stop device by moving the upper portion of the stopper until it locks with its lower portion.

24. The method for using a trigger stop device with a video game controller of claim 23, further comprising the steps of
depressing a trigger of the video game controller until the trigger reaches the release point;
releasing the trigger;
allowing the trigger to rebound; and
depressing the trigger of the video game controller a second time, until it reaches the release point.
